(19) United States
(12) Patent Application Publication
(10) Pub. No.: US 2008/0142139 A1
(43) Pub. Date: Jun. 19, 2008

(54) Pneumatic Vehicle Tire with Reinforced Bead Construction

(75) Inventors: Martin Josef Kraus, Hannover (DE); Heinz-Bernhard Mazur, Wedemark (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 11/968,397

(22) Filed: Jan. 2, 2008

Related U.S. Application Data
(63) Continuation of application No. PCT/EP2006/004873, filed on May 23, 2006.

(30) Foreign Application Priority Data
Jul. 1, 2005 (DE) 10 2005 030 819.8

(51) Int. Cl. B60C 9/12

(52) U.S. Cl. 152/458

(57) ABSTRACT

A radial pneumatic vehicle tire, in particular a truck tire, includes a carcass insert having at least one ply and reinforcing elements of steel cord or a material of similar strength. The carcass insert is turned back in a bead region about a bead core to form a turn-up. At least one fabric reinforcing ply with tension-resistant, textile reinforcing elements, reinforces the bead region, runs around the bead core, has one side directly contacting the bead core and another side directly contacting the carcass insert and reaches on an inner tire side between a bead filler and the carcass insert, up to a height measured radially relative to a rim transition point of between 0.1 and 0.47 of a cross-sectional height of the tire and ending on an outer tire side, between the bead filler and the turn-up of the carcass insert, at a distance radially inside the turn-up.

### CROSS-REFERENCE TO RELATED APPLICATIONS

This is a continuing application, under 35 U.S.C. § 120, of copending International Application No. PCT/EP2006/004873, filed May 23, 2006, which designated the United States; this application also claims the priority, under 35 U.S.C. § 119, of German Patent Application No. DE 10 2005 030 819.8, filed Jul. 1, 2005; the prior applications are herewith incorporated by reference in their entirety.

### BACKGROUND OF THE INVENTION

### Field of the Invention

The invention relates to a pneumatic vehicle tire, in particular for trucks, having a radial type of construction, with a single-ply or multi-ply carcass insert having reinforcing elements of steel cord or a material of similar strength. The carcass insert is turned back in bead regions about bead cores to form turn-ups, and the bead regions are reinforced with at least one reinforcing ply, in particular a number of reinforcing plies. The reinforcing ply or plies take the form of a fabric ply or fabric plies with tension-resistant, textile reinforcing elements.

Such a tire is known, for example, from German Published, Non-Prosecuted Patent Application DE 30 43 726 A, corresponding to European Patent No. EP 05 27 37 B1. According to a preferred embodiment, that tire is reinforced in the bead region by four fabric plies. The plies are disposed in such a way that they respectively extend between the carcass insert and the outer wall of the tire, which is formed either by the inner layer or the sidewall.

European Patent Application EP 1 129 870 A, corresponding to U.S. Pat. No. 6,543,502, discloses a run-flat tire, which can consequently run for a certain time without internal air pressure. The tire is reinforced for that purpose with crescent-shaped reinforcing profiles of rubber in the sidewalls and in the bead regions, respectively with at least one steel-cord-reinforced additional ply between the bead filler and the carcass insert.

U.S. Pat. No. 4,852,626 discloses a bead reinforcement for a truck tire, in which the carcass insert extends in the vicinity of the bead core between two steel-cord-reinforced reinforcing plies which are disposed in a specific way and the reinforcing elements of which are disposed in such a way that they cross one another.

There are even further bead reinforcing structures for truck tires, both for fifteen degree and five degree tapered seat tires. One of these bead reinforcing structures has between two and four fabric plies in a cross bracing assembly, which extend radially outside the turn-back of the carcass insert, lie against one another and are staggered in relation to one another. In the case of five degree tapered seat tires, generally three or four fabric plies disposed in this way are provided. In the case of another known configuration, a single ply of rubberized steel cords is provided as a bead reinforcer and extends radially outside the carcass turn-up and underneath the bead core. In the case of a further alternative using a bead reinforcer ply with steel cords as a reinforcing element, that ply extends not only radially outside the turn-up but also completely around the bead core and on the inner side relatively far alongside the bead filler. In the case of truck tires, which are intended to withstand particularly high loads, it is also known to provide combinations of reinforcing plies with textile reinforcing elements and reinforcing plies with steel cords as reinforcing elements.

Due to the low weight, as well as lower production costs, there is a desire to also be able to provide bead reinforcer assemblies that are exclusively fabric plies with textile reinforcing elements in truck tires as well that can withstand high loads.

### BRIEF SUMMARY OF THE INVENTION

It is accordingly an object of the invention to provide a pneumatic vehicle tire with a reinforced bead construction, which overcomes the hereinafore-mentioned disadvantages of the heretofore-known devices of this general type and which includes a bead reinforcer having at least one fabric ply with textile reinforcing elements, thereby ensuring required durability and service life of the tire, in accordance with its intended use.

With the foregoing and other objects in view there is provided, in accordance with the invention, a pneumatic vehicle tire, in particular for trucks, having a radial type of construction, comprising a single-ply or multi-ply carcass insert with reinforcing elements of steel cord or a material of similar strength, the carcass insert being turned back in bead regions about bead cores to form turn-ups, and the bead regions being reinforced with at least one reinforcing ply, in particular a number of reinforcing plies, the reinforcing ply (plies) taking the form of a fabric ply (fabric plies) with tension-resistant, textile reinforcing elements. A textile reinforcing ply which is provided runs around the bead core, on one side in direct contact with the bead core and on the other side in direct contact with the carcass insert, reaches on the inner side of the tire, between the bead filler and the carcass insert, up to a height relative to a rim transition point, measured in the radial direction, that is between 0.1 and 0.47 of the cross-sectional height of the tire and ends on the outer side of the tire, between the bead filler and the turn-up of the carcass insert, at a distance radially inside the turn-up.

It has been found that, depending on the area of use, a single textile reinforcing ply running around the bead core and surrounded on the outside by the carcass insert is adequate to reinforce the bead regions of truck tires in such a way that the desired durability and load-bearing capacity is achieved. It is possible to dispense with the use of steel cords in reinforcing plies in the bead region. The reinforcing ply which is provided in any event according to the invention thereby at the same time replaces the otherwise customary flipper strip. The invention makes many advantageous configurations of the reinforcement and stiffening of the bead regions possible and consequently allows tires to be optimized for their intended use.

In accordance with another feature of the invention, it may be of advantage if at least one further textile reinforcing ply extends on the inside of the tire between the carcass insert and the bead filler and/or if at least one of these further textile reinforcing plies runs at least partially around the bead core.

In accordance with a further preferred feature of the invention, the reinforcing ply extending in direct contact with the bead core reaches, on the side of the turn-up of the carcass, up to a height, measured from the rim transition point, that is between 10% and 80% of the height of the turn-up, which is likewise measured from the rim transition point. This measure is advantageous for the already mentioned replacement of the flipper strip by this reinforcing ply.

In accordance with an added feature of the invention, in the case of truck tires, which are intended to withstand particularly high loads, up to three further textile reinforcing plies may be provided, extending exclusively on the inner side of the tire between the carcass insert and the bead filler.

In accordance with an additional feature of the invention, this allows a specific reinforcement of the bead by a configuration in which the end near the bead core of each further reinforcing ply reaches at most up to the beginning of the portion of the carcass insert extending radially inside the bead core.

In accordance with yet another feature of the invention, the fabric ply composite becomes particularly durable if at least one of the further reinforcing plies extends between the reinforcing ply running around the bead core and the bead filler.

In accordance with yet a further feature of the invention, as an alternative thereto, a specific reinforcement of the bead region can also be achieved in the critical region by at least one of the further reinforcing plies extending between the reinforcing ply that runs around the bead core and the carcass insert.

In accordance with yet an added feature of the invention, a further possibility of influencing specific advantageous properties of the bead regions of a tire is provided in the case of a fabric ply composite by staggering the ends of the reinforcing plies. In this case, the radially outer and/or radially inner ends of the reinforcing plies may be disposed in such a way that they are staggered in relation to one another.

In accordance with yet an additional feature of the invention, the mutual configuration of the ends of a number of textile reinforcing plies is particularly variable. An optimum range of the distance between the ends of neighboring reinforcing plies with staggering of the same lies in a range between 7 mm and 20 mm.

In accordance with again another feature of the invention, a further possibility of placement of the reinforcing plies, and consequently providing the entire multi-ply composite with specific properties, is the mutual configuration of the textile reinforcing elements in the reinforcing plies neighboring one another in a cross bracing assembly.

In accordance with a concomitant feature of the invention, the orientation of the textile reinforcing elements in the individual reinforcing plies with respect to the circumferential direction of the tire is of significance for the properties, and consequently the intended use, of the tire with such a bead assembly. In this case, the angle of the reinforcing elements can be chosen very variably, in particular between 4° and 80° in relation to the circumferential direction.

Other features which are considered as characteristic for the invention are set forth in the appended claims.

Although the invention is illustrated and described herein as embodied in a pneumatic vehicle tire with a reinforced bead construction, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, cross-sectional view of a truck tire;

FIGS. 2 to 5 are respective fragmentary, cross-sectional views of one of the bead regions of a truck tire, each including an embodiment of the invention;

FIGS. 6A to 6D are fragmentary, cross-sectional views showing possibilities of staggering radially further out ends of three reinforcing plies;

FIGS. 7A to 7D are fragmentary, cross-sectional views showing possibilities of staggering other ends of three reinforcing plies; and

FIGS. 7E to 7H are fragmentary, cross-sectional views showing further embodiments of the invention, in which two of the reinforcing plies extend under a bead core.

### DETAILED DESCRIPTION OF THE INVENTION

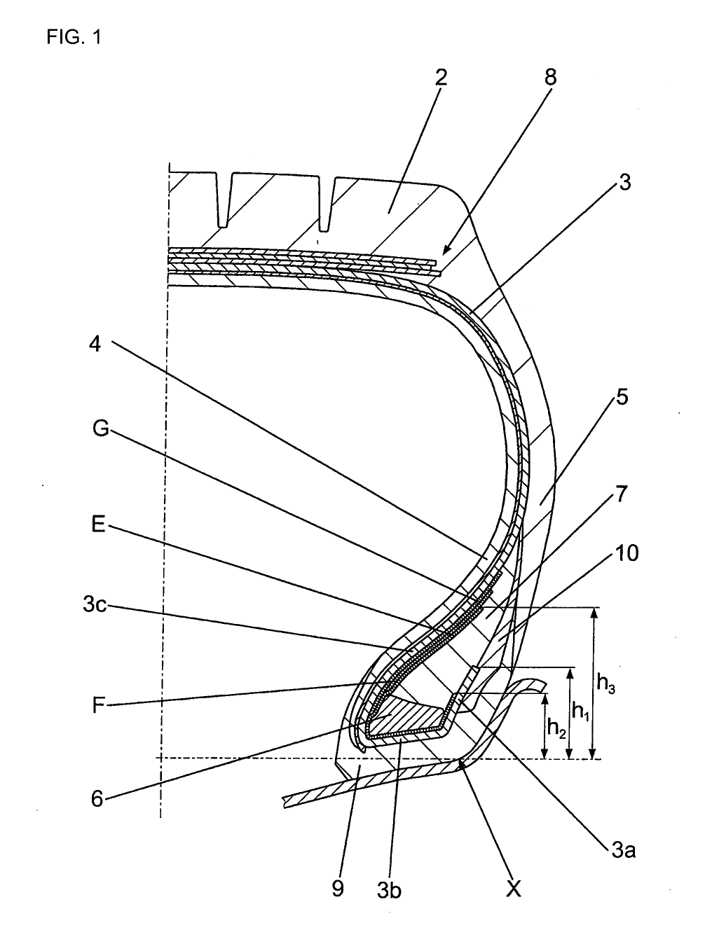

Referring now to the figures of the drawings in detail and first, particularly, to FIG. 1 thereof, there is seen a diagrammatic illustration of one half of a truck tire in cross section, in which a rim is also indicated in a bead region. Of the components of the truck tire, a tread rubber 2, a carcass insert 3, a multi-ply breaker belt 8, an inner layer 4 (in particular double-ply), one of the sidewalls 5, one of the bead cores 6, one of the bead fillers 7, one of the chafers 9 and one of the additional rubber profiles 10 between the sidewall 5 and the bead filler 7, are shown. The carcass insert 3 has, in particular, steel cords as reinforcing elements, which extend at right angles or substantially at right angles to the circumferential direction of the tire. The bead core 6 is formed of steel cables, and the bead filler 7 disposed radially outside the bead core 6 and seated on it is formed of a rubber mixture with a high modulus of elasticity and may also be of a multi-part form, and consequently formed of rubber mixtures of different moduli of elasticity. The carcass insert 3, coming from the breaker belt 8, is placed from the inside to the outside around each bead core 6 and, to explain the invention, is represented by three portions 3a, 3b, 3c merging one into the other. The portion 3a is a carcass turn-up, the portion 3b is that which extends radially inside the respective bead core 6 and the portion 3c adjoins the latter and extends in the direction of the breaker belt, for instance up to a point with the greatest cross-sectional width of the tire. The carcass insert 3 is preferably constructed in its shape in such a way that, as FIG. 1 shows, it largely or completely follows a neutral contour. An end of the turn-up 3a reaches up to a height h₁, which is measured from a rim transition point X in radial direction and is between 17 and 70 mm.

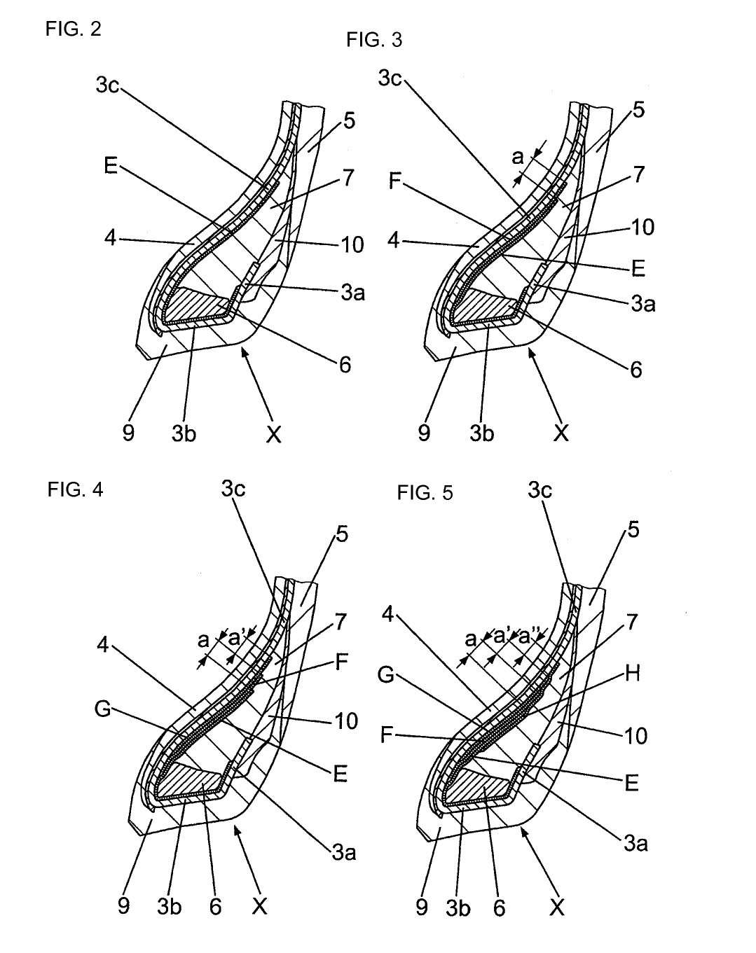

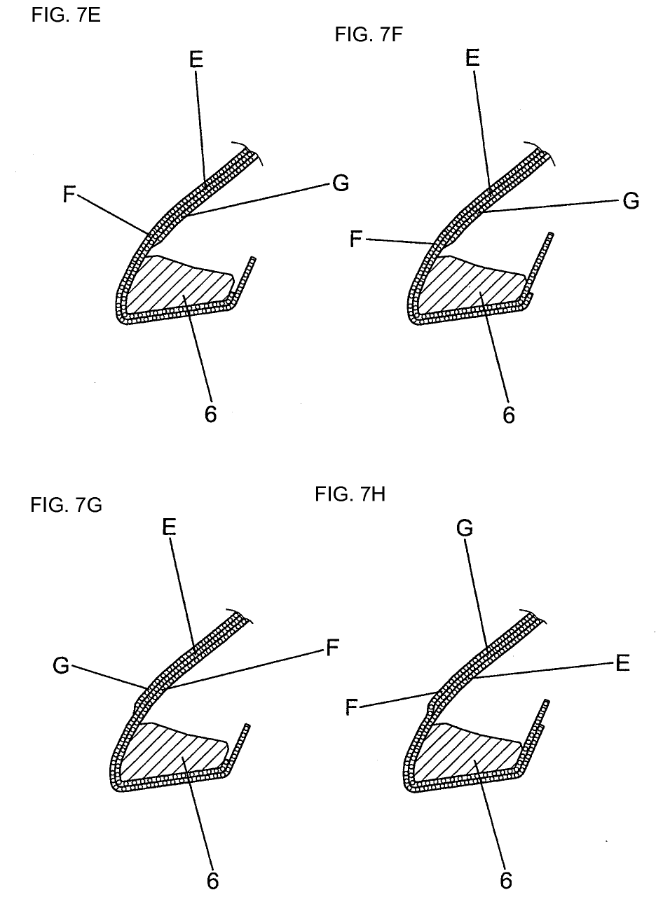

According to the invention, the bead regions of the tire are reinforced in a special way, depending on the embodiment, with one to four textile reinforcing plies E to H. All of the reinforcing plies E, F, G, H are rubberized fabric plies having tension-resistant textile reinforcing elements. Polyester, aramid or polyamide, as well as mixed or hybrid cords (for example aramid-polyamide), for example, come into consideration as the material for the textile reinforcing elements. As FIGS. 2 to 5 show, the reinforcing plies E, F, G, H extend between the bead filler 7 and the portion 3c of the carcass insert 3. The three plies F, G, H are exclusively there, while the ply E additionally runs around the bead core 6 and is in direct contact therewith. FIGS. 7E to 7H show embodiments with three reinforcing plies E, F, G, in which one of these plies, the ply E, runs around the core 6 and a further ply, F or G, extends at least underneath the core 6. On the side of the turn-up 3a, the ply E ends before the end of the turn-up 3a at a height h₂ which, measured from the rim transition point X in the radial direction, is between 10 and 80% of the height h₁. On the other side of the bead core 6 or the bead filler 7, the reinforcing ply E reaches up to a height h₃, which is measured from the rim transition point X in the radial direction, is greater than h₁ and is between 0.1 and 0.47 of the cross-sectional height of the tire. The heights h₁, h₂ and h₃ are only depicted in FIG. 1, which shows a configuration with three reinforcing plies E, F, G in the bead region.

FIG. 2 shows an embodiment of the invention in which the bead region of the tire is merely reinforced with one ply, the reinforcing ply E.

In the case of the embodiment shown in FIG. 3, the reinforcing ply F, which is located between the portion 3c of the carcass insert 3 and the reinforcing ply E, is provided in addition to the reinforcing ply E. With respect to the bead core 6, the ply F begins approximately halfway along the radial extent of the bead core 6. A second end of the reinforcing ply F protrudes beyond the reinforcing ply E by a length a, which is between 7 and 20 mm.

The embodiment shown in FIG. 4 has three reinforcing plies E, F, G. The configuration of the ply E corresponds to that of the embodiment according to FIG. 3. The ply F is located between the ply E and the ply G, which lies against the portion 3c of the carcass insert 3, has one end which reaches to the bead core 6 and protrudes in the radial direction beyond the end of the reinforcing ply F, to be precise by a length a′, which is between 7 and 20 mm.

In the case of the configurational variant of the invention shown in FIG. 5, a fourth reinforcing ply H is provided, which extends between the portion of the reinforcing ply E (running round the bead core 6) that extends along the portion 3c of the carcass insert 3, and the bead filler 7. In the case of the configuration represented, in the direction of the bead core 6, the reinforcing ply H begins just radially outside the bead core 6 and protrudes with its other end beyond all of the reinforcing plies E, F, G and beyond the reinforcing ply G by a length a″ of from 7 to 20 mm. The lengths a, a′ are to be determined by analogy with the embodiments according to FIGS. 3 and 4.

An included angle which the textile cords in one of the plies E, F, G, H form with the radial direction is between 4° and 80°. In the case of configurations with a number of reinforcing plies E, F to E, F, G, H, these are preferably disposed in a cross bracing assembly. The textile cords extending in neighboring reinforcing plies E, F, G, H cross one another. The choice of the angles of the textile cords in the individual reinforcing plies E, F, G, H allows an optimization of the durability and load-bearing capacity of the tire beads, in particular to make the tire particularly suitable for specific uses.

A mutual configuration of the two to four reinforcing plies E, F, G, H is possible with different staggerings, likewise for optimizing and adapting the load-bearing capacity of the tire to specific intended uses.

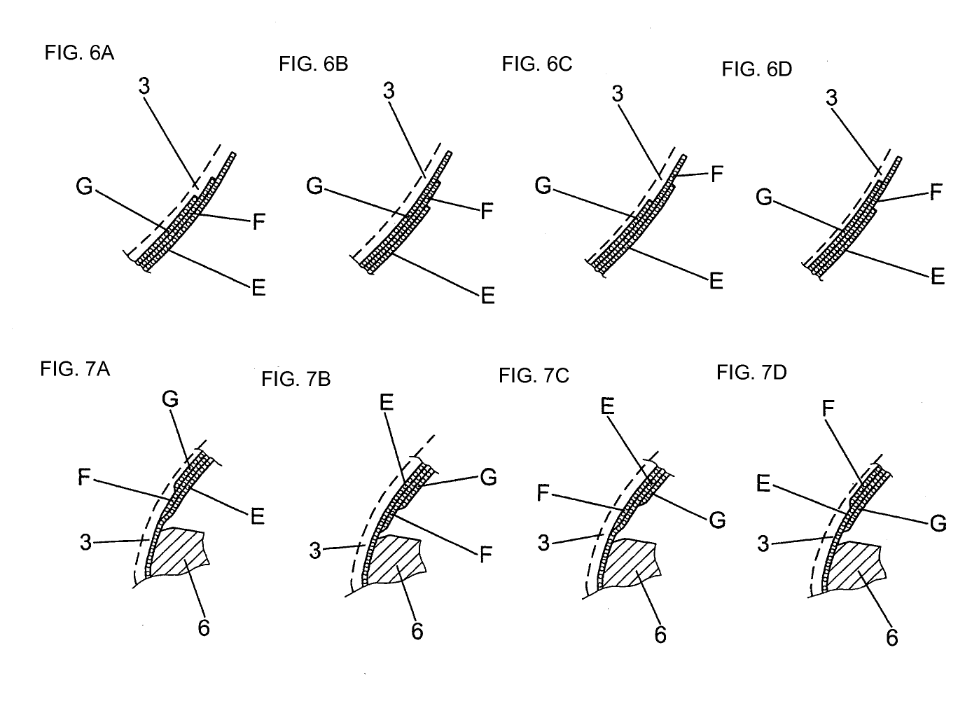

FIGS. 6A and 6B show variants of the staggering of the upper ends, on the basis of the configuration with three reinforcing plies E, F, G. In FIG. 6A, an upper staggering of the three reinforcing plies E, F, G that is open with respect to the carcass insert 3 is represented. FIG. 6B shows a staggering of the three reinforcing plies E, F, G that is closed or covered with respect to the carcass insert 3. In the case of the configuration shown in FIG. 6C, a centering staggering of the three reinforcing plies E, F, G that is closed with respect to the carcass insert 3 is provided, with the middle ply F reaching the furthest and the ply G that is in contact with the carcass insert 3 being the shortest. In the case of the configuration shown in FIG. 6D, a centering staggering that is open with respect to the carcass insert 3 is provided, in which the middle ply F is that which reaches the furthest, and the ply E that is in contact with the non-illustrated bead filler is the shortest of the three plies E, F, G.

FIGS. 7A to 7D show possibilities of staggering the end portions of three reinforcing inserts E, F, G that are near the bead core 6. The ply E in this case is that which runs around the bead core 6. In the case of the embodiment according to FIG. 7A, the reinforcing ply E is also that which extends in contact with the bead filler, and the further plies F and G adjoin the ply E in the direction of the carcass insert 3. The two plies F and G are staggered such that they are open with respect to the carcass insert 3. In the case of the variant shown in FIG. 7B, the reinforcing ply E is that which is in contact with the carcass insert 3, with the two further plies F and G adjoining the direction of the bead filler in such a way that a staggering of these three plies E, F, G that is closed with respect to the carcass insert 3 is obtained. In the case of the embodiments according to FIGS. 7C and 7D, the reinforcing ply E is the middle of the three plies E, F, G which are provided, with the staggering in FIG. 7C providing that the ply F reaches closer to the bead core 6 than the ply G. The converse is the case in FIG. 7D.

FIGS. 7E to 7F show further possibilities of the staggering or configuration of the end portions near the bead core 6, in the case of configurations in which two reinforcing plies are wrapped around the bead core 6 and run at least partially around it. FIG. 7E shows a staggering on the outer side of the bead core 6, with the reinforcing ply E that is lying directly against the bead core 6 ending lower down than the reinforcing ply F extending further out and reaching further. In FIG. 7F, the ply E lying directly against the bead core 6 reaches further than the end of the second ply F. In the case of these variants, the ply G is the ply that lies against the bead filler 6. FIG. 7G is analogous to FIG. 7E, and the ply G is in contact with the carcass insert 3. In FIG. 7H, two plies E and F that run around the bead core 6 end outside the widest extent of the bead core 6 on the outer side of the same. The ply G is located between the plies E and F and ends with the lower end either alongside or radially outside the bead core 6.

Analogous staggerings and configurations are possible in the case of configurational variants with two reinforcing plies E and F and in the case of embodiments with four reinforcing plies E, F, G, H.

The invention is not restricted to the embodiments represented. For example, configurations in which the lengths of the portions of reinforcing plies that protrude beyond one another are less than 7 mm or greater than 20 mm are possible. Furthermore, it is of advantage if the reinforcing elements in the reinforcing ply that reaches furthest in the radial direction extend at an angle that comes closest to the angle of the reinforcing elements in the carcass insert.

1. A radial pneumatic vehicle tire, comprising:
an inner tire side, an outer tire side, a cross-sectional tire height and a rim transition point;
a bead region having a bead core and a bead filler;
a carcass insert having at least one ply and reinforcing elements of steel cord or a material of similar strength, said carcass insert being turned back in said bead region about said bead core to form a turn-up; and
at least one fabric reinforcing ply with tension-resistant, textile reinforcing elements, said at least one reinforcing ply reinforcing said bead region, running around said bead core, having one side in direct contact with said bead core and another side in direct contact with said carcass insert and reaching on said inner side of the tire between said bead filler and said carcass insert, up to a height measured in radial direction relative to said rim transition point of between 0.1 and 0.47 of said cross-sectional height of the tire and ending on said outer side of the tire, between said bead filler and said turn-up of said carcass insert, at a distance radially inside said turn-up.

2. The pneumatic vehicle tire according to claim 1, wherein said at least one reinforcing ply includes at least one further textile reinforcing ply extending on said inside of the tire between said carcass insert and said bead filler.

3. The pneumatic vehicle tire according to claim 2, wherein said at least one further textile reinforcing ply runs at least partially around said bead core.

4. The pneumatic vehicle tire according to claim 1, wherein said at least one reinforcing ply running around said bead core reaches, on a side of said turn-up of said carcass, up to a height measured from said rim transition point, of between 10% and 80% of a height of said turn-up, measured from said rim transition point.

5. The pneumatic vehicle tire according to claim 1, wherein said at least one reinforcing ply includes up to three further textile reinforcing plies.

6. The pneumatic vehicle tire according to claim 5, wherein said carcass insert has a portion extending radially inside said bead core with a beginning, and each of said further reinforcing plies has an end near said bead core reaching at most up to said beginning of said portion.

7. The pneumatic vehicle tire according to claim 5, wherein at least one of said further reinforcing plies extends between said at least one reinforcing ply running around said bead core and said bead filler.

8. The pneumatic vehicle tire according to claim 5, wherein at least one of said further reinforcing plies extends between said at least one reinforcing ply running around said bead core and said carcass insert.

9. The pneumatic vehicle tire according to claim 5, wherein said further textile reinforcing plies include at least one of radially outer or radially inner ends being mutually staggered.

10. The pneumatic vehicle tire according to claim 9, wherein said staggered ends of adjacent reinforcing plies define distances therebetween of 7 mm to 20 mm.

11. The pneumatic vehicle tire according to claim 5, wherein said textile reinforcing elements in mutually adjacent reinforcing plies are disposed in a cross bracing assembly.

12. The pneumatic vehicle tire according to claim 5, wherein said textile reinforcing elements in said reinforcing plies form an included angle with a circumferential direction of the tire of between 4° and 80°.

13. The pneumatic vehicle tire according to claim 1, wherein said carcass insert has a portion extending inside a sidewall and at least mostly or completely following a neutral contour.

14. The pneumatic vehicle tire according to claim 1, wherein said bead filler has a multi-part structure and is formed of rubber mixtures with different moduli of elasticity.

15. The pneumatic vehicle tire according to claim 1, wherein the tire is a truck tire.
